(19) United States
(12) Patent Application Publication
(10) Pub. No.: US 2025/0013427 A1
(43) Pub. Date: Jan. 9, 2025

(54) Smart Headphones with User Authentication

(71) Applicant: FINNOVATE GROUP, LLC, Solana Beach, CA (US)

(72) Inventor: Kari Kristian Rauhala, Solana Beach, CA (US)

(21) Appl. No.: 18/766,486

(22) Filed: Jul. 8, 2024

Related U.S. Application Data
(60) Provisional application No. 63/525,621, filed on Jul. 7, 2023.

(51) Int. Cl. G06F 3/16; H04R 1/10

(52) U.S. Cl. CPC G06F 3/165; H04R 1/10; H04R 2420/07

(57) ABSTRACT

Smart, multi-mode headphones for a user. The headphones one or two loudspeakers that fit over, on, or in the user's ear, each of the loudspeakers being configured to deliver audio signals to an ear of the user in an audio play mode. The headphones further include an authentication system integrated with the headphones, the authentication system being configured to authenticate the user of the headphones to determine the audio play mode, from a plurality of audio play modes, based on the authentication.

### CROSS REFERENCE TO RELATED APPLICATION

This application claims the benefit of U.S. Provisional Application No. 63/525,621, filed Jul. 7, 2023, entitled “Smart Headphones with User Authentication”, the disclosure of which is incorporated, in its entirety by this reference.

### BACKGROUND

Headphones are electronic devices used to deliver audio to a user. Some headphones can accommodate and deliver the audio directly to the user's ears, using air conduction via a transducer, as with small loudspeakers that fit over (102), on, or in (104) the user's ear, as shown in FIG. 1. Other headphones can be bone conducting (BC) speakers that conduct sound vibrations to the user's ear via the user's skull bones. Still other headphones can be a combination of both direct audio and bone conducting.

While tremendous advancement has been made with the audio quality of headphones, headphones can become more capable with the advancement of new chipsets and low-power technology, and much like smart watches today, smart headphones will be next. Accordingly, what is needed is a new archetype for headphones that takes into account modern processing capabilities and ability to provide for multiple automated modes.

### SUMMARY

This document presents smart headphones having a number of modes, and which can function or not based on user authentication or authentication of an environment or use of the headphones.

In some aspects, smart, multi-mode headphones for a user are disclosed. The headphones one or two loudspeakers that fit over, on, or in the user's ear, each of the loudspeakers being configured to deliver audio signals to an ear of the user in an audio play mode. The headphones further include an authentication system integrated with the headphones, the authentication system being configured to authenticate the user of the headphones to determine the audio play mode, from a plurality of audio play modes, based on the authentication.

In other aspects, smart, multi-mode headphones for a user to play audio signals from a wireless network are disclosed. The headphones include one or two loudspeakers that fit over, on, or in the user's ear, each of the loudspeakers being configured to deliver audio signals to an ear of the user in an audio play mode. The headphones further include an authentication system integrated with the headphones, the authentication system being configured to authenticate the user of the headphones to determine the audio play mode, from a plurality of audio play modes, based on the authentication. The headphones further include a wireless transceiver to communicate with the wireless network for receiving the audio signals to deliver to the user via the loudspeakers.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 shows several air conducting headphones; and

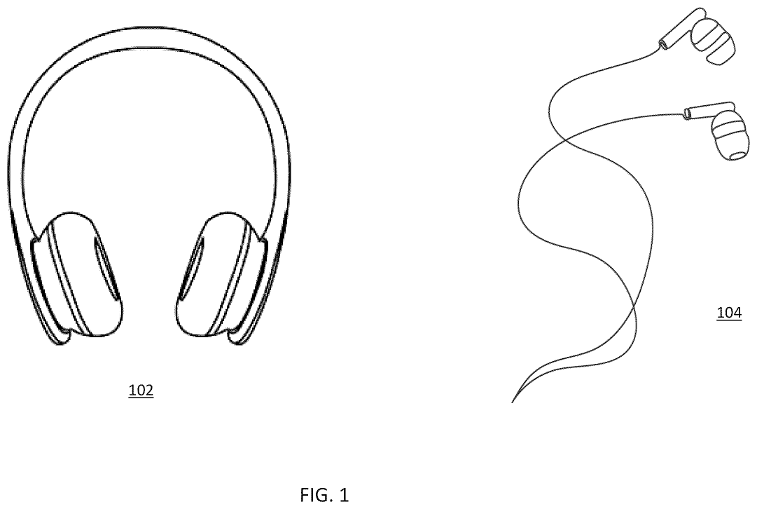

FIG. 2 shows bone conducting headphones with additional control features and sensors.

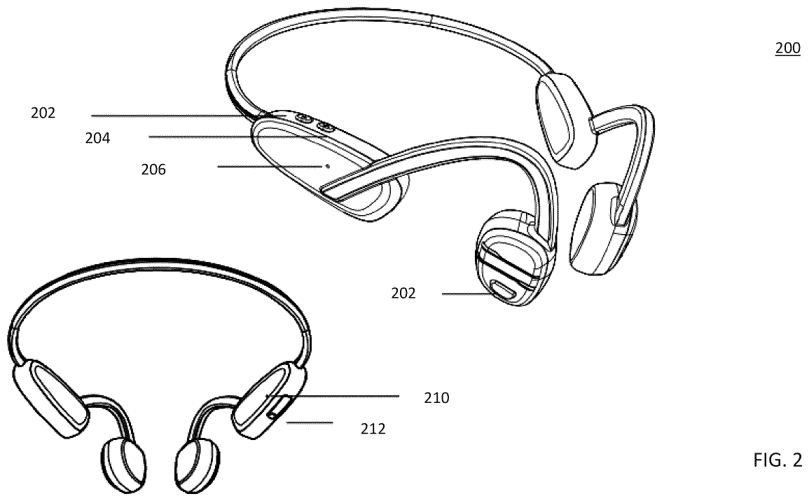

Like reference symbols in the various drawings indicate like elements.

### DETAILED DESCRIPTION

This document describes smart headphones, with user authentication and selective mode functions. The smart headphones can have a number of modes that can be based on user authentication and/or an environment in which the smart headphones is used. The user authentication and mode-section features and functions can be implemented in computer logic in hardware, software, firmware, or any combination thereof, that is associated with or integrated with the headphones. For example, the headphones can include processor circuitry that executes machine-readable instructions. Or, the headphones can include a processor, such as a field programmable gate array (FPGA) or application specific integrated circuit (ASIC) that is configured to execute hard-wired instructions to accomplish the functions described herein.

In preferred implementations, the smart headphones can have several modes. For example, an “anonymous” mode allows the user to use the headphones as normal headphones and perhaps connect to their smart phone via Bluetooth to receive streaming audio. But in some implementations, the headphones can be configured with an “authenticated” mode where the user has gone through a set-up process to create a user account for or associated with the smart headphones. The set-up process can be done via an application (or “app”) running on a remote computing device, such as a smartphone, and that enables the authentication of the user and advanced features to be used, such as direct user connection to wireless networks, automatic access to apps for audio delivery, downloading of audio (or other media) content, etc.

Accordingly, in some preferred implementations, in the authenticated mode the smart headphone set-up process and subsequent authentication of the user may include, without limitation, one or more of: a Personal Identification Number (PIN); an audio password or audio signature (i.e., voice recognition); and/or fingerprint sensor, as the smart headphones buttons or a dedicated area may include a fingerprint sensor to authenticate the user. For the PIN, the user may create a pass code by pressing one or more headphone buttons, such as user controls 204, in a specific sequence or pattern, and then repeat that sequence or pattern on the headphone buttons to authenticate the user each time the headphones are used. The user controls 204 can have other functions once the user is authenticated, such as, for example and without limitation: volume UP; volume DOWN; song skip; song back-skip; fast-forward or reverse; and/or song selection. In this context, the term “song” merely refers to a digital audio file, and can include voice, music, or other audio.

Other ways to authenticate the user and unlock the headphones include NFC detection, in which the smart headphones may also be unlocked by the user via Near Field Connection (NFC) 208 with another trusted device, such as a smartphone, smart watch or computer. The user may also unlock the smart headphones via Bluetooth® connection, i.e., where an app is configured to send the PIN to the headphones, such as by user entry of the PIN in a touch screen or display with user input.

Authentication of the user, either by the headphones, a connected electronic media delivery device, or both, will enable autonomous features that can be implemented without the presence of other devices. Accordingly, the headphones can be independent in the autonomous mode.

In some implementations, the smart headphones can connect themselves autonomously to wireless networks, and/or apps on a portable electronic device connected to one or more of the wireless networks, to receive content, audio, alerts, weather data, etc. For example, based on geo-location data or global positioning system (GPS) data, the smart headphones can connect to a ski report app or website if the user is near a ski resort, or a surf report app or website if the user is near a surfing spot. Or, if the smart headphones and/or any electronic device connected with the smart headphones is detected to be within a shopping environment, an app or the headphones can receive and deliver audio related to deals, specials, or information about certain specific commercial merchandise.

In other examples, authenticated smart headphones can be linked into user's personal account, such as a streaming service account. Once authenticated, user's headphones can be enabled to download new music files, enable music updates and audio services. Authentication can also be used to access WiFi networks, cellular networks, applications on a computing device such as a smartphone, a laptop, a desktop computer, etc., or other functions.

In some implementations, authentication is expired as soon as (or with a short timed delay) the headphones are removed from the user's head or ears. The detection of headphone removal can be done by light sensors that detect ambient light. The sensor can be inserted in the area where, when headphones are on the user's head, is close to the skin and blocking the ambient light. If the sensor detects a change in the ambient light, i.e., exposed to more light when the headphones are removed—where the headphones can then be locked, or rendered unusable until the user is next authenticated.

Other methods to expire the authentication can include, without limitation, where the smart headphone sensors, such as gyroscopes, movement sensors, accelerometers, etc., detect no movement for a period of time. Alternatively, or complementarily, the authentication can be revoked by using the same methods as unlocking or authenticating the headphones.

The smart headphones may locally store the user account and locally stored content to enable quick access for the user when authenticated. i.e. the audio content maybe downloaded and locally stored, but assigned to a specific user whereby access to the certain content is granted by authentication of that specific user.

The smart headphones can be assigned to multiple user accounts, such as by mapping a device ID to one or more user IDs or one or more device IDs. Each user is unique and authenticated separately, so that, for example, a smart headphones can be used by a family—when authenticated by one family member—the content is unlocked and updated for that specific user and available to all related users.

Although a few embodiments have been described in detail above, other modifications are possible. Other embodiments may be within the scope of the following claims.

1. Smart, multi-mode headphones for a user, the headphones comprising:
one or two loudspeakers that fit over, on, or in the user's ear, each of the loudspeakers being configured to deliver audio signals to an ear of the user in an audio play mode; and
an authentication system integrated with the headphones, the authentication system being configured to authenticate the user of the headphones to determine the audio play mode, from a plurality of audio play modes, based on the authentication.

2. The headphones in accordance with claim 1, wherein the authentication system includes a processor for receiving input from the user to perform the authentication.

3. The headphones in accordance with claim 2, wherein the headphones includes one or more user input buttons to provide the input from the user to perform the authentication.

4. The headphones in accordance with claim 2, wherein the processor is an FPGA.

5. The headphones in accordance with claim 1, wherein the headphones include a wireless transceiver to communicate to a wireless network for receiving the audio signals to deliver to the user via the loudspeakers.

6. The headphones in accordance with claim 5, wherein the headphones are further configured to connect autonomously to the wireless network.

7. The headphones in accordance with claim 6, further comprising a global positioning system (GPS) integrated with the headphones, to provide geo-location data of the headphones to the wireless network.

8. Smart, multi-mode headphones for a user to play audio signals from a wireless network, the headphones comprising:
one or two loudspeakers that fit over, on, or in the user's car, each of the loudspeakers being configured to deliver audio signals to an ear of the user in an audio play mode;
an authentication system integrated with the headphones, the authentication system being configured to authenticate the user of the headphones to determine the audio play mode, from a plurality of audio play modes, based on the authentication;
a wireless transceiver to communicate with the wireless network for receiving the audio signals to deliver to the user via the loudspeakers.

9. The headphones in accordance with claim 8, further comprising a global positioning system (GPS) integrated with the headphones, to provide geo-location data of the headphones to the wireless network.

10. The headphones in accordance with claim 8, wherein the headphones are further configured to connect autonomously to the wireless network based on the authentication.
